(19) United States
(12) Patent Application Publication
(10) Pub. No.: US 2020/0027078 A1
(43) Pub. Date: Jan. 23, 2020

(54) ELECTRONIC SYSTEMS AND COMPUTERIZED METHODS FOR PROCESSING PAYMENT OF TRANSACTIONS AT A MERCHANT USING A PREFUNDED PAYMENT TOKEN

(71) Applicant: Mastercard International Incorporated, Purchase, NY (US)

(72) Inventors: Manu Dharmaiah Kallugudde, Mumbai (IN); Saket Bhardwaj, Mumbai (IN); Vijin Venugopalan, Singapore (SG)

(21) Appl. No.: 16/507,755

(22) Filed: Jul. 10, 2019

(30) Foreign Application Priority Data
Jul. 19, 2018 (SG) 10201806191R

(51) Int. Cl. G06Q 20/36; G06Q 20/28

(52) U.S. Cl. CPC G06Q 20/3674; G06Q 20/28

(57) ABSTRACT

The present disclosure generally relates to an electronic system and computerized method for processing payment of transactions. In various embodiments, there is a payment network server for processing payment of transactions between a consumer and a merchant. The payment network server comprises a tokenization request module, an authorization module, a token management module, and a communication module.

### CROSS-REFERENCE TO RELATED APPLICATION

This application is a U.S. National Stage filing under 35 U.S.C. § 119, based on and claiming benefits of and priority to Singapore Patent Application No. 10201806191R filed on Jul. 19, 2018. The entire disclosure of the above application is incorporated herein by reference for all purposes.

### TECHNICAL FIELD

The present disclosure generally relates to electronic systems and computerized methods for processing payment of transactions at a merchant using a prefunded payment token. Particularly, the present disclosure describes various embodiments of electronic systems and computerized methods for tokenizing a payment instrument of a consumer to generate the prefunded payment token which is stored at the merchant, for payment of the transactions at the merchant using the prefunded payment token.

### BACKGROUND

E-commerce or internet retailing has been gaining popularity among consumers due to the convenience provided to consumers in delivering purchased products directly to the consumers. Various e-commerce transactions between a consumer and merchants are performed online, such as with the consumer's computer or mobile phone. The transactions are normally paid for using a payment instrument of the consumer, such as a credit card. Credit card details can be digitized and stored on the computer or mobile phone, as well as other electronic devices such as wearables and keys. Currently, there are various ways to digitize credit cards for secure payment of transactions. For example, tokenization allows consumers to digitize their credit cards into an electronic device and use them for payment of transactions with merchants. The user experience is similar to that as existing swipe or card chip transactions.

To improve the user experience, the details or credentials of a consumer payment instrument such as a credit card may be stored with a merchant. During payment of transactions with the merchant, the consumer can easily retrieve the credit card details, for example, from the merchant. Such transactions are known as card-on-file transactions and expedite the overall payment process. However, one problem with card-on-file transactions is that consumers still have to retrieve the credit card details and submit them via the merchant online checkout page. For example, the credit card details may be auto-populated at the merchant online checkout page before submission to initiate the payment process. Thus, each transaction still has to be processed through the payment network, and often involves security measures such as one-time passwords (OTP) for each transaction. This can be cumbersome to consumers especially if they want to perform more frequent transactions such as bill payments.

Therefore, in order to address or alleviate at least one of the aforementioned problems and/or disadvantages, there is a need to provide an electronic system and computerized method with an improvement in payment of transactions.

### SUMMARY

According to a first aspect of the present disclosure, there is a payment network server, a computerized method, and a non-transitory computer-readable storage medium comprising instructions for processing payment of transactions between a consumer and a merchant. The payment network server comprises a tokenization request module, an authorization module, a token management module, and a communication module configured for performing steps of the method.

The tokenization request module is configured for: receiving, from the merchant, a request for tokenization of a payment instrument of the consumer, the tokenization request comprising details of the consumer payment instrument and details of the merchant.

The authorization module is configured for: communicating, to an issuer server for the consumer payment instrument, a request for authorization of the consumer payment instrument, the authorization request comprising the consumer payment instrument details; and receiving an authorization response from the issuer server, the authorization response comprising authorization of a funds value for payment of the transactions.

The token management module is configured for: generating a prefunded payment token according to the tokenization request, the prefunded payment token associated with the consumer payment instrument, the merchant, and the funds value.

The communication module is configured for: communicating, to the merchant, details of the prefunded payment token for storing on a database of the merchant and for subsequent communication to the consumer, the prefunded payment token details comprising an identifier thereof and the funds value, wherein the transactions are payable using the prefunded payment token by deducting, by the merchant, from a balance of the funds value.

According to a second aspect of the present disclosure, there is a payment network server, a computerized method, and a non-transitory computer-readable storage medium comprising instructions for processing payment of transactions between a consumer and a merchant. The method is performed by a server of the merchant and comprises: receiving, from an electronic device of the consumer, a request for tokenization of a payment instrument of the consumer, the tokenization request comprising details of the consumer payment instrument; communicating the tokenization request to a payment network server, the tokenization request further comprising details of the merchant; receiving, from the payment network server, details of the prefunded payment token generated by the payment network server, the prefunded payment token associated with the consumer payment instrument, the merchant, and a funds value for payment of the transactions, the prefunded payment token details comprising an identifier thereof and the funds value; storing the prefunded payment token details on a database of the merchant; and communicating the prefunded payment token details to the consumer, wherein the funds value is authorized by an issuer server for the consumer payment instrument; and wherein the transactions are payable using the prefunded payment token by deducting, by the merchant, from a balance of the funds value.

According to a third aspect of the present disclosure, there is a payment network server, a computerized method, and a non-transitory computer-readable storage medium comprising instructions for processing payment of transactions between a consumer and a merchant using a prefunded payment token. The method is performed by a server of the merchant and comprises: receiving a request for a transaction from the consumer, the transaction request comprising details of the prefunded payment token and a transaction amount of the transaction; retrieving, from the merchant database, a balance of a funds value of the prefunded payment token based on the details thereof; deducting the transaction amount from the funds value balance for payment of the transaction in response to a determination that the transaction amount is less than or equal to the funds value balance; and updating the funds value balance of the prefunded payment token on the merchant database, wherein the prefunded payment token is generated by a payment network server and is associated with the merchant, a payment instrument of the consumer, and the funds value authorized by an issuer server for the consumer payment instrument.

Electronic systems and computerized methods for processing payment of the transactions using the prefunded payment token, according to the present disclosure are thus disclosed herein. Various features, aspects, and advantages of the present disclosure will become more apparent from the following detailed description of the embodiments of the present disclosure, by way of non-limiting examples only, along with the accompanying drawings briefly described below.

### BRIEF DESCRIPTION OF THE DRAWINGS

FIG. 1 is an illustration of an electronic system for processing payment of transactions using a prefunded payment token, in accordance with embodiments of the present disclosure.

FIG. 2 is a flowchart illustration of a computerized method implemented on a payment network server for processing payment of transactions using a prefunded payment token, in accordance with embodiments of the present disclosure.

FIG. 3 is a flowchart illustration of a computerized method implemented on a merchant server for processing payment of transactions using a prefunded payment token, in accordance with embodiments of the present disclosure.

FIG. 4 is a schematic illustration of a computerized method implemented on the electronic system of FIG. 1 for processing payment of transactions using a prefunded payment token, in accordance with embodiments of the present disclosure.

FIG. 5 is a flowchart illustration of a computerized method implemented on a merchant server for processing payment of transactions using a prefunded payment token, in accordance with embodiments of the present disclosure.

FIG. 6 is a block diagram illustration of the technical architecture of a server, in accordance with embodiments of the present disclosure.

### DETAILED DESCRIPTION

In the present disclosure, depiction of a given element or consideration or use of a particular element number in a particular figure or a reference thereto in corresponding descriptive material can encompass the same, an equivalent, or an analogous element or element number identified in another figure or descriptive material associated therewith. The use of “I” in a figure or associated text is understood to mean “and/or” unless otherwise indicated. For purposes of brevity and clarity, descriptions of embodiments of the present disclosure are directed to electronic systems and computerized methods for processing payment of transactions at a merchant using a prefunded payment token, in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e. a skilled person, that the present disclosure may be practiced without specific details, and/or with multiple details arising from combinations of aspects of particular embodiments. In a number of instances, known systems, methods, procedures, and components have not been described in detail so as to not unnecessarily obscure aspects of the embodiments of the present disclosure.

### Overview

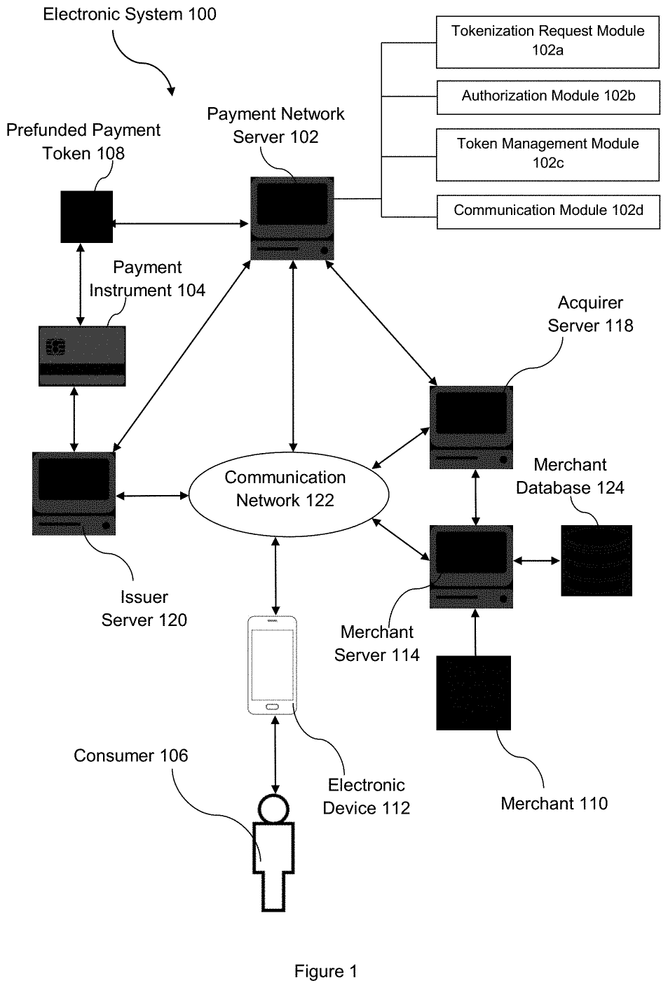

In representative or exemplary embodiments of the present disclosure, there is an electronic or computer system 100 including a payment network server 102 for processing payment of transactions. Particularly, the payment network server 102 tokenizes a payment instrument 104 of a consumer 106, such as a credit card, to generate a prefunded payment token 108 for payment of the transactions which are performed between the consumer 106 and a merchant 110, as illustrated in FIG. 1. The merchant 110 may be a business or commercial entity that offers products for purchase by the consumer 106 through the transactions. The system 100 includes an electronic device 112 which the consumer 106 uses to browse online catalogs of the merchant 110 and to perform the transactions. The system 100 further includes a server 114 of the merchant 110, an acquirer server 118 for the merchant 110, and an issuer server 120 for the consumer payment instrument 104. The payment network server 102, consumer electronic device 112, merchant server 114, acquirer server 118, and issuer server 120 are communicable with one another through a communication network 122.

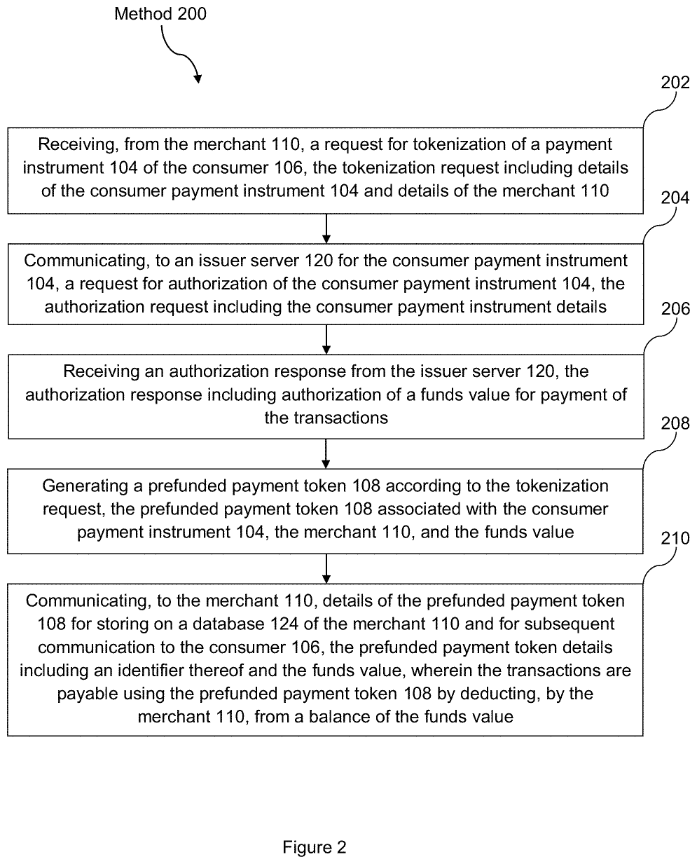

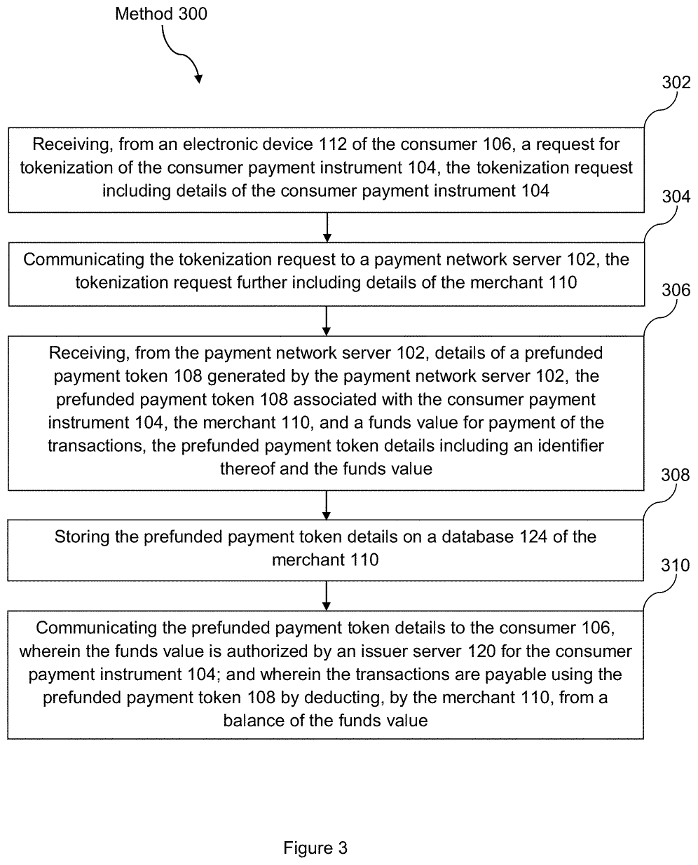

With reference to FIG. 2, there is shown a computer-implemented or computerized method 200 implemented on the payment network server 102 for processing payment of the transactions. The payment network server 102 includes various modules/components for performing various operations or steps of the method 200, including a tokenization request module 102a, an authorization module 102b, a token management module 102c, and a communication module 102d. Further with reference to FIG. 3, there is shown a corresponding computer-implemented or computerized method 300 implemented on the merchant server 114 for processing payment of the transactions.

In a step 302 of the method 300, the merchant server 114 receives, from the consumer electronic device 112, a request for tokenization of the consumer payment instrument 104, the tokenization request including details of the consumer payment instrument 104. The tokenization request is initiated by the consumer 106 using the consumer electronic device 112 and via an application, interface, website, or platform hosted on the merchant server 114. The tokenization request includes the consumer payment instrument details such as credit card number and expiry date, as well as details of the merchant 110 such as identification details thereof.

In a step 304 of the method 300, the merchant server 114 communicates, to the payment network server 102, a request for tokenization of the consumer payment instrument 104. The tokenization request may be communicated from the merchant server 114 to the acquirer server 118 and subsequently to the payment network server 102 through the communication network 122. Correspondingly, in a step 202 of the method 200, the tokenization request module 102a of the payment network server 102 receives the tokenization request from the merchant 110.

In a step 204, the authorization module 102b of the payment network server 102 communicates, to the issuer server 120 for the consumer payment instrument 104, a request for authorization of the consumer payment instrument 104, the authorization request including the consumer payment instrument details. The authorization request is for the issuer server 120 to verify the details of the consumer payment instrument 104 and is subsequently processed by the issuer server 120 in a standard manner readily known to the skilled person. Furthermore, the authorization request includes authorization of a funds value for payment of the transactions. In a step 206, the authorization module 102b receives an authorization response from the issuer server 120.

In a step 208, the token management module 102c generates the prefunded payment token 108 according to the tokenization request. Specifically, the prefunded payment token 108 is associated with the consumer payment instrument 104 and the merchant 110. In other words, the prefunded payment token 108 is unique to the consumer payment instrument 104 and the merchant 110, and cannot be used for payment of transactions with other merchants. The prefunded payment token 108 is also associated with the funds value. The funds value is authorized by the issuer server 120 in the authorization response and defines the funding amount for the prefunded payment token 108. The funds value thus represents the total amount funded or stored on the prefunded payment token 108 and which can be used to pay for transactions with the merchant 110.

In a step 210, the communication module 102d communicates, to the merchant 110, details of the prefunded payment token 108 for storing on a database of the merchant and for subsequent communication to the consumer 106. The details of the prefunded payment token 108 include an identifier thereof and the funds value. Correspondingly, in a step 306, the merchant server 114 receives the details of the prefunded payment token 108 generated by and from the payment network server 102.

In a step 308, the merchant server 114 stores the prefunded payment token details on a database 124 of the merchant 110. The merchant database 124 is a repository of details of prefunded payment tokens 108 of the consumer 106 as well as of other consumers. In a step 310, the merchant server 114 communicates the prefunded payment token details to the consumer 106. For example, the consumer 106 may receive, view, and save the prefunded payment token details on the consumer electronic device 112.

Therefore, with the system 100, method 200, and method 300, the consumer 106 can use the prefunded payment token 108 to pay for transactions with the merchant 110. Specifically, payment of the transactions includes deducting from a balance of the funds value by the merchant 110. The merchant 110 can deduct the transaction amounts from the funds value balance as the funds value has already been authorized by the issuer server 120. Transactions paid using the prefunded payment token 108 can be expedited as they do not have to go through the standard payment process, which involves the merchant server 114 communicating with the acquirer server 118 and subsequently the payment network server 102 and issuer server 120 for authorization of each and every transaction. This obviates the need for the consumer 106 to enter an OTP communicated from the issuer server 120 each and every time a transaction is performed. The merchant 110 is able to accept payments with the prefunded payment token 108 directly within its internal payment processing system. Thus, the consumer 106 will be able to see that transactions are completed faster, thereby improving user experience especially for high frequency, low value transactions such as bill payments where faster completion of the transactions are desired.

### Description of Embodiments

References to “an embodiment/example”, “another embodiment/example”, “some embodiments/examples”, “some other embodiments/examples”, and so on, indicate that the embodiment(s)/example(s) so described may include a particular feature, structure, characteristic, property, element, or limitation, but that not every embodiment/example necessarily includes that particular feature, structure, characteristic, property, element or limitation. Furthermore, repeated use of the phrase “in an embodiment/example” or “in another embodiment/example” does not necessarily refer to the same embodiment/example.

The terms “comprising”, “including”, “having”, and the like do not exclude the presence of other features/elements/steps than those listed in an embodiment. Recitation of certain features/elements/steps in mutually different embodiments does not indicate that a combination of these features/elements/steps cannot be used in an embodiment.

As used herein, the terms “component”, “module,” “system”, “apparatus”, “interface”, and the like are generally intended to refer to a computer-related entity, either hardware, a combination of hardware and software, software, or software in execution. For example, a component or a module may be, but is not limited to being, a process running on a processor, a processor, an object, an executable, a thread of execution, a program, and/or a computer. By way of illustration, both an application running on a controller and the controller can be a component/module. One or more components/modules may reside within a process and/or thread of execution. A component/module may be localized on one computer and/or distributed among a plurality of computers.

As used herein, the terms “a” and “an” are defined as one or more than one. The term “set” is defined as a non-empty finite organization of elements that mathematically exhibits a cardinality of at least one (e.g. a set as defined herein can correspond to a unit, singlet, or single-element set, or a multiple-element set), in accordance with known mathematical definitions. The recitation of a particular numerical value or value range herein is understood to include or be a recitation of an approximate numerical value or value range.

While various terms as used in representative or exemplary embodiments of the present disclosure are defined herein, the definitions of these terms are not intended to be limited as such and are in addition to their plain meanings according to standard English dictionaries.

In various embodiments of the present disclosure, the electronic system 100 includes the payment network server 102 for processing payment of transactions between the consumer 106 and the merchant 110. The system 100 further includes the consumer electronic device 112, merchant server 114, acquirer server 118, and issuer server 120, wherein one or more or all of which are communicable with one another through the communication network 122.

The payment network server 102 is a computer server associated with a payment network of various payment instruments and which is operated by a payment network operator. Typically, the payment network operator facilitates communications between acquirer institutions and issuer institutions to authorize and fund transactions performed using consumer payment instruments 104. The payment network settles the transactions between various acquirer institutions and issuer institutions, when consumer payment instruments 104 such as credit cards are used for initiating transactions including payment transactions between consumers 106 and merchants 110. An example of a payment network is the Banknet payment network operated by Mastercard. In many embodiments, the payment network server 102 and the payment network associated therewith facilitate the payment of transactions between the consumer 106 and the merchant 110. The payment network may be integrated with or complements the communication network 122 to facilitate said payment of transactions. Furthermore, the payment network server 102 also processes transactions paid using the consumer payment instrument 104. The payment network server 102 generates credit and/or debit notifications based on payment of a transaction using the consumer payment instrument 104. The credit and/or debit notifications are communicated to the acquirer server 118 and issuer server 120 for crediting and/or debiting the respective financial accounts corresponding to the merchants 110 and consumers 106. More specifically, upon said payment of a transaction, the consumer payment instrument 104 is debited and the merchant financial account is credited, thereby transferring funds from the consumer payment instrument 104 to the merchant financial account.

The consumer 106 is an individual who is an account holder of an account which refers to any financial account, such as current account, savings account, trading account, or any account associated with the consumer payment instrument 104. In some embodiments, the account is a bank account maintained by a financial institution, such as an issuer institution or bank. In some other embodiments, the account is a digital wallet maintained by a merchant 110, the payment network operator, an issuer institution or bank, or a third-party service provider. The account is linked to the consumer payment instrument 104 and thus the consumer payment instrument 104 stores identification information of the account. The account identification information may be stored in the form of an electronic chip or a machine-readable magnetic strip embedded in the consumer payment instrument 104. The account identification information may include an account number and the name of the account holder (i.e. consumer 106). The consumer payment instrument 104 has a unique identifier, an expiry date, security data, and type. The payment instrument identifier, expiry date, security data, and type constitute details of the consumer payment instrument 104.

The consumer payment instrument 104 refers to any suitable cashless payment mechanism, such as payment cards or transaction cards, which the consumer 106 may use to perform transactions, such as deposits and withdrawals, credit transfers, purchase payments, payment transactions, and the like. In some embodiments, the consumer payment instrument 104 is a physical card, such as credit card, debit card, membership card, promotional card, contactless card, charge card, frequent flyer card, gift card, prepaid card, or the like. The consumer payment instrument 104 may be radio frequency identification (RFID) or near field communication (NFC) enabled for performing contactless payment transactions. In some other embodiments, the consumer payment instrument 104 is stored electronically in memory of the consumer electronic device 112, such as on an application or digital wallet resident or operative on the consumer electronic device 112.

The consumer electronic device 112 is an electronic communication device that enables the consumer 106 to purchase goods, products, and/or services through e-commerce sites (e.g. card-not-present payment transactions) or at a point-of-sale (POS) terminal (e.g. physical in-store payment transactions) associated with the merchant 110. The consumer electronic device 112 may be a mobile device, mobile phone, smartphone, personal digital assistant (PDA), key fob, transponder device, NFC-enabled device, tablet, phablet, laptop, computer, other communication device, or the like.

In many embodiments, the consumer payment instrument 104 is associated with or linked to the prefunded payment token 108 generated by the payment network server 102. Details of the consumer payment instrument 104 and details of the merchant 110 are communicated from the merchant 110 to the payment network server 102 to request for tokenization of the consumer payment instrument 104. Said communication occurs through the merchant server 114 and acquirer server 118.

The merchant 110 is a business or commercial entity that offers various merchandise, goods, products, and/or services in exchange for payments. The merchant 110 may establish an account with a financial institution, such as an acquirer institution or bank to accept the payments from the consumers 106 by use of the prefunded payment token 108 and consumer payment instrument 104. The merchant 110 operates the merchant server 114 that is a computer server associated with an e-commerce site on which transactions can be initiated by the consumers 106. The merchant server 114 may also be communicatively linked to a merchant apparatus or a POS terminal in a merchant's retail premises.

The acquirer server 118 is a computer server operated by an acquirer institution or bank at which merchants including the merchant 110 maintain merchant accounts to receive and accept payments for goods, products, and/or services purchased by the consumers 106. Account information of the merchant accounts established with the acquirer institution is stored as account profiles in an acquirer database of the acquirer institution. The acquirer database may reside locally on the acquirer server 118, or alternatively on a remote or cloud server communicatively linked to the acquirer server 118. The acquirer server 118 receives the tokenization request from the merchant server 114 and communicates the tokenization request to the payment network server 102. The acquirer server 118 is configured for crediting the financial account of the merchant 110 maintained in the acquirer institution upon payment of a transaction.

The issuer server 120 is a computer server operated by an issuer institution or bank Issuer or issuer bank where accounts of consumers 106 are established and maintained. The issuer institution ensures payment for authorized payment transactions in accordance with various payment network regulations and local legislation. Account information of the accounts established with the issuer institution is stored as account profiles in an issuer database of the issuer institution. The issuer database may reside locally on the issuer server 120, or alternatively on a remote or cloud server communicatively linked to the issuer server 120. The account information may include an account balance, a credit line, details of an account holder, transaction history of the account holder, account identification information, and the like. The details of the account holder may include identification number, name, age, gender, date of birth, physical attributes, contact numbers, email addresses, and the like of the account holder. The issuer server 120 is configured for debiting the consumer payment instrument 104, or an account of the consumer 106 linked thereto that is maintained in the issuer institution, upon payment of a transaction.

As used herein, the term “institution” is not necessarily limited to organizations which are legally constituted as banks. In some jurisdictions or countries, other organizations may be permitted to maintain financial accounts such as a payment card account. An institution may thus be one of the following: a bank, financial technology company, and financial institution. It will be appreciated that the acquirer server 118 and issuer server 120 receive various credit and debit notifications/messages from the payment network server 102. Based on the credit and debit notifications, the acquirer server 118 credits the merchant account and issuer server 120 debits the consumer account or consumer payment instrument 104 linked thereto. It will be further appreciated that said crediting and debiting via the acquirer server 118 and issuer server 120 respectively will be readily apparent to the skilled person and may include processing via the conventional four-party system or three-party system.

The communication network 122 is a medium or environment through which content, notifications, and/or messages are communicated among various entities, including the payment network server 102, consumer electronic device 112, merchant server 114, acquirer server 118, and issuer server 120. Some non-limiting examples of the communication network 122 include a virtual private network (VPN), wireless fidelity (Wi-Fi) network, light fidelity (Li-Fi) network, local area network (LAN), wide area network (WAN), metropolitan area network (MAN), satellite network, Internet, fiber optic network, coaxial cable network, infrared (IR) network, radio frequency (RF) network, and any combination thereof. Various entities in the communication network 122 may connect to the communication network 122 in accordance with various wired and wireless communication protocols, such as Transmission Control Protocol/Internet Protocol (TCP/IP), User Datagram Protocol (UDP), 2nd to 5th Generation (2G to 5G) communication protocols, Long Term Evolution (LTE) communication protocols, and any combination thereof. Each of the payment network server 102, consumer electronic device 112, merchant server 114, acquirer server 118, and issuer server 120 includes a communication or transceiver module to communicate and transmit/receive data over the communication network 122. Some non-limiting examples of a transceiver module include an antenna module, a radio frequency transceiver module, a wireless transceiver module, a Bluetooth transceiver module, an Ethernet port, a Universal Serial Bus (USB) port, or any other module/component/device configured for transmitting and receiving data.

In some embodiments, alternative or additional to an account established with the acquirer institution, the merchant 110 has established an account with a payment aggregator or payment facilitator which provides a service for merchants to process payment of transactions. The payment aggregator operates an aggregator server that aggregates various merchants including the merchant 110 on a single platform. As with the payment network server 102, acquirer server 118, and issuer server 120 at least, the aggregator server is communicable with other entities through the communication network 122. The payment aggregator provides an interface between the merchant server 114 and payment network server 102, so that the merchant 110 may not need to setup an account with the acquirer institution. In one embodiment, the payment network server 102 and aggregator server are separate entities. The aggregator server may receive the tokenization request from the merchant server 114 and communicates the tokenization request to the payment network server 102. In another embodiment, the functionalities of the aggregator server are integrated into the payment network server 102 such that they operate as an integrated or single entity. It will be appreciated that the merchant server 114 is communicable with the acquirer server 118 or aggregator server depending on whether the merchant 110 has an account with the acquirer institution or payment aggregator, respectively.

In various embodiments, a software or mobile application is installed/resident/operative/executable on the consumer electronic device 112 to access an online website/interface/platform of the merchant 110 hosted on the merchant server 114. The website/interface/platform may present to the consumer 106 an online catalog of merchandise, goods, products, and/or services offered by the merchant 110. The website/interface/platform may include a payment gateway or checkout page at which the consumer 106 can inputs details of the consumer payment instrument 104 for payment of the transactions. The consumer payment instrument details may be previously stored on the merchant database 124 such that the details can be auto-populated at the payment gateway or checkout page.

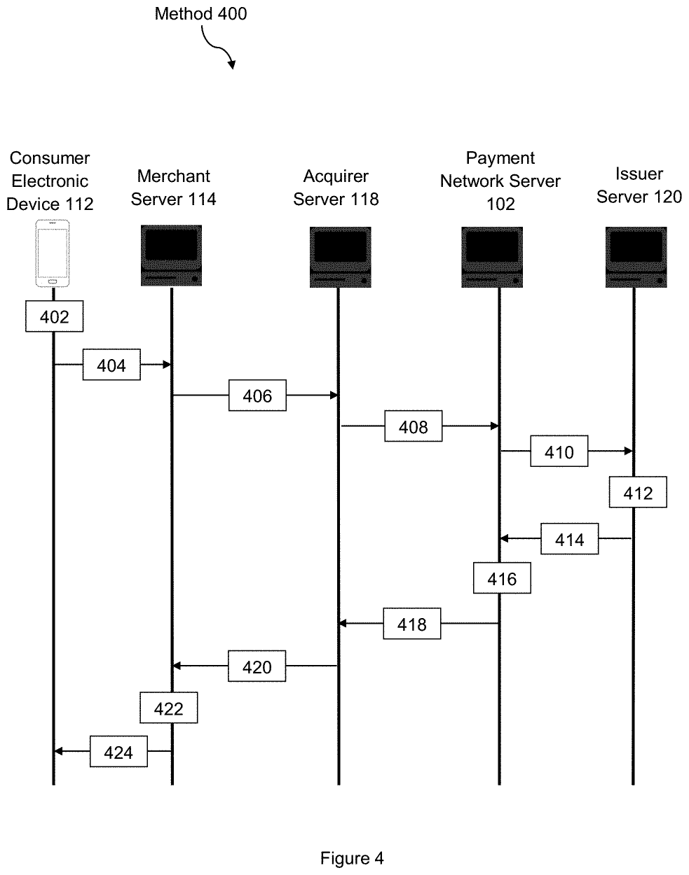

Instead of the consumer payment instrument 104, the consumer 106 may use the prefunded payment token 108 to pay for the transactions. Details of the prefunded payment token 108, such as an identifier thereof, may be input or auto-populated at the payment gateway or checkout page. If the consumer 106 does not already have a prefunded payment token 108, he/she may request for one via the merchant website/interface/platform. In various embodiments with reference to FIG. 4, there is a computer-implemented or computerized method 400 implemented on the system 100 for tokenizing the consumer payment instrument 104 for payment of the transactions.

In a step 402 of the method 400, the consumer 106 initiates through the merchant 110, specifically the merchant website/interface/platform accessible on the consumer electronic device 112, a request for tokenization of the consumer payment instrument 104. In a step 404, the merchant server 114 receives the tokenization request from the consumer electronic device 112, the tokenization request including details of the consumer payment instrument 104, such as credit card number and expiry date. The consumer payment instrument details may further include authentication details such as a security code or PIN. In a step 406, the merchant server 114 communicates the tokenization request to the acquirer server 118 through the communication network 122. The tokenization request includes the consumer payment instrument details and further includes details of the merchant, such as identification details thereof. It will be appreciated that the consumer payment instrument details and merchant details are in accordance with one or more standards for the interchange of payment transaction messages, such as the ISO 8583 standard. In some embodiments, the tokenization request also includes identification details of the consumer 106, such as login details of the consumer 106 for accessing the merchant website/interface/platform.

In a step 408, the tokenization request module 102a of the payment network server 102 receives the tokenization request from the acquirer server 118. In a step 410, the authorization module 102b of the payment network server 102 communicates, to the issuer server 120 for the consumer payment instrument 104, a request for authorization of the consumer payment instrument 104. The authorization request includes the consumer payment instrument details and is in accordance with one or more standards for the interchange of payment transaction messages, such as the ISO 8583 standard.

In a step 412, the issuer server 120 processes the authorization request. Particularly, the issuer server 120 verifies the details of the consumer payment instrument 104 against the issuer database. Optionally, the issuer server 120 communicates an authentication request to the consumer 106 requesting the consumer 106 to provide authentication details for the consumer payment instrument 104, such as a security code and/or one-time password (OTP). For example, the issuer server 120 may communicate a text message to the consumer electronic device 112 containing the OTP which the consumer 106 is required to input via the merchant website/interface/platform. Conventionally, in order to authorize the consumer payment instrument 104, the issuer server 120 is configured for verifying one or more of the credit card number, expiry date, and authentication details of the consumer payment instrument 104. In a step 414, the authorization module 102b of the payment network server 102 receives an authorization response from the issuer server 120. The authorization response indicates if the consumer payment instrument 104 is authorized or declined, and is in accordance with one or more standards for the interchange of payment transaction messages, such as the ISO 8583 standard.

Furthermore, the authorization response includes authorization of a funds value for payment of the transactions. The funds value defines the funding amount for the prefunded payment token 108. The funds value thus represents the total amount funded or stored on the prefunded payment token 108 and which can be used to pay for transactions with the merchant 110. In the step 412, the issuer server 120 also authorizes the funds value. Particularly, the issuer server 120 checks an available balance or funds of the account of the consumer 106 linked to the consumer payment instrument 104 to determine if the available balance is sufficient for the funds value. The available balance may include any overdraft balance available to the consumer account. The issuer server 120 then authorizes the funds value if the consumer payment instrument details are verified and that the available balance is equal to or more than the funds value. Upon authorization, the funds value is reserved and blocked out from the available balance.

In one embodiment, the funds value is determined by the consumer 106 and the funds value is included in the tokenization request initiated by the consumer 106 in the step 402. Consequently, the authorization request also includes the funds value for authorization by the issuer server 120 in the step 412. In another embodiment, the funds value is determined by the merchant 110 and the funds value is included in the tokenization request communicated to the payment network server 102 in the steps 406 and 408. Consequently, the authorization request also includes the funds value for authorization by the issuer server 120 in the step 412. In yet another embodiment, the authorization module 102b determines the funds value before communicating the authorization request to the issuer server 120. Consequently, the authorization request includes the funds value for authorization by the issuer server 120 in the step 412. In yet another embodiment, the funds value is determined by the issuer server 120 based on the available balance or funds of the consumer payment of the account of the consumer 106 linked to the consumer payment instrument 104.

In a step 416, the token management module 102c of the payment network server 102 generates the prefunded payment token 108 according to the tokenization request. As will be readily understood by the skilled person, tokenization of the consumer payment instrument 104 replaces sensitive data of the consumer payment instrument 104 with secure surrogate data in the form of tokens such as the prefunded payment token 108. The token management module 102c may be implemented in a host application or platform such as the Mastercard Digital Enablement Service (MDES) provided by Mastercard.

The prefunded payment token 108 is associated with the consumer payment instrument 104 and the merchant 110. In other words, the prefunded payment token 108 is unique to the consumer payment instrument 104 and the merchant 110, and cannot be used for payment of transactions with other merchants. The prefunded payment token 108 is also associated with the funds value for payment of the transactions with the merchant 110.

Accordingly, transactions with the merchant 110 are payable using the prefunded payment token 108. Specifically, said payment of the transactions includes deducting from a balance of the funds value by the merchant 110. For example, the funds value may be $100 and the consumer 106 may use the prefunded payment token 108 to pay directly to the merchant 110 for transactions up to a collective total of $100. The funds value balance is reduced with each transaction paid using the prefunded payment token 108 until it reaches zero, upon which the consumer 106 may be requested to replenish or allocate more funds to the prefunded payment token 108.

In one embodiment, the prefunded payment token 108 is further associated a common transaction value for each transaction. A transaction with the merchant 110 is payable using the prefunded payment token 108 if the transaction amount is less than or equal to the common transaction value. The common transaction value may be determined by the consumer 106, merchant 110, payment network server 102, or issuer server 120. For example, the common transaction value may be $10 and limits the transaction amount of each transaction to be $10 or less. This may be helpful to consumers 106 in controlling their spending on low-value products. In another embodiment, the prefunded payment token 108 is further associated with an allowed number of the transactions. A transaction with the merchant is payable using the prefunded payment token 108 if previous transactions are fewer than the allowed number. The allowed number may be determined by the consumer 106, merchant 110, payment network server 102, or issuer server 120. For example, the allowed number may be 10 and limits the number of transactions that can be paid using the prefunded payment token 108. If the allowed number has been reached, the merchant 110 may inform the consumer 106 and request the consumer 106 to take appropriate action to reset the allowed number.

In some embodiments, the tokenization request includes the consumer identification details and the prefunded payment token 108 is associated with the consumer payment instrument 104, merchant 110, and consumer 106. Particularly, the prefunded payment token 108 can only be used by the consumer 106 using his/her login details for accessing the merchant website/interface/platform, wherein the login details are included in the consumer identification details. Furthermore, the same consumer payment instrument 104 may be tokenized to generate a set of prefunded payment tokens 108. For example, the token management module 102c is configured for generating a second prefunded payment token 108 associated with the consumer payment instrument 104, the merchant 110, and a second consumer. Although the consumer payment instrument 104 is in the name of the consumer 106 (first consumer) and not in the name of the second consumer, the first consumer 106 may have allowed the second consumer to use the consumer payment instrument 104, such as if the second consumer is a close relative or spouse of the first consumer 106. The second consumer may initiate a tokenization request to tokenize the consumer payment instrument 104 and generate the second prefunded payment token 108 which can only be used by the second consumer and for payment of transactions with the merchant 110.

In a step 418, the communication module 102d of the payment network server 102 communicates, to the acquirer server 118, details of the prefunded payment token 108 for subsequent communication to the merchant 110 and consumer 106. In a step 420, the merchant server 114 receives the prefunded payment token details from the acquirer server 118. The prefunded payment token details include an identifier thereof and the funds value. Notably, the prefunded payment token identifier is different from the identifier of the consumer payment instrument 104, such as credit card number. Optionally, prefunded payment token details further include the common transaction value and/or allowed number of transactions.

In a step 422, the merchant server 114 stores the prefunded payment token details on the merchant database 124. The merchant database 124 is a repository of details of prefunded payment tokens 108 of the consumer 106 as well as of other consumers. The merchant database 124 may reside locally on the merchant server 114, or alternatively on a remote or cloud server communicatively linked to the merchant server 114. The merchant 110 then communicates the prefunded payment token details to the consumer 106. Specifically, in a step 424, the merchant server 114 communicates the prefunded payment token details to the consumer electronic device 112 so that the consumer 106 can view the prefunded payment token details. The consumer 106 may save a record of the prefunded payment token details on the consumer electronic device 112 so it can be easily retrieved for future transactions with the merchant 110. Furthermore, the consumer 106 may use another consumer electronic device 112 to access the merchant application/platform and retrieve the prefunded payment token details stored on the merchant database 124. Accordingly, the prefunded payment token details are communicable from the merchant server 114 to the consumer electronic device 112 and/or other electronic devices of the consumer 106.

Storing the prefunded payment token details on the merchant database 124 provides a secure way for processing of transactions. Sensitive details of the consumer payment instrument 104, such as credit card information, are replaced with secured surrogate data in the prefunded payment token 108. The prefunded payment token details communicate across the payment network for transaction processing, instead of the sensitive credit card information, thereby mitigating risk of misuse of credit card information. It will be appreciated that the storage and communication of the prefunded payment token details are similar to that for tokens used in card-on-file transactions.

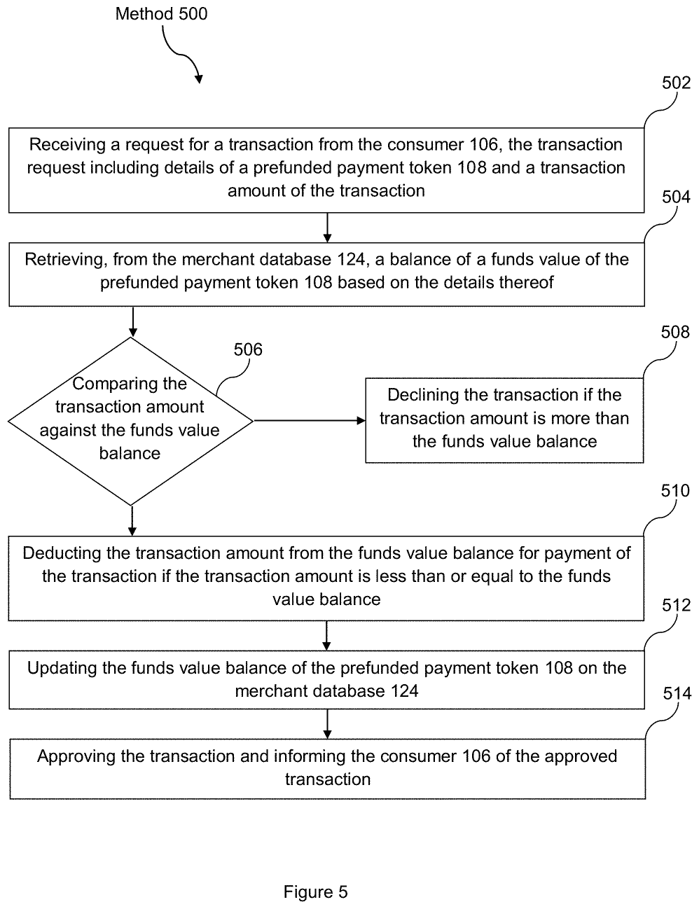

Therefore, with the method 400 implemented on the system 100, the transactions between the consumer 106 and the merchant 110 are payable using the prefunded payment token 108. In various embodiments with reference to FIG. 5, there is a computer-implemented or computerized method 500 implemented on the system 100, and specifically performed the merchant server 114, for payment of transactions between the consumer 106 and merchant 110 using the prefunded payment token 108. As described in various embodiments above, the prefunded payment token 108 is generated by the payment network server 102 and is associated with the merchant 110, the consumer payment instrument 104, and the funds value which is authorized by an issuer server for the consumer payment instrument.

In a step 502 of the method 500, a transaction request module of the merchant server 114 receives a request for a transaction from the consumer 106. Particularly, the consumer 106 uses the consumer electronic device 112 to communicate the transaction request to the merchant server 114, such as through the merchant website/interface/platform. The transaction request includes details of the prefunded payment token 108, such as the prefunded payment token identifier, and a transaction amount of the transaction. In one embodiment, the prefunded payment token identifier is manually entered by the consumer 106 at the payment gateway or checkout page of the merchant website/interface/platform. In another embodiment, the consumer 106 has login details to access the merchant website/interface/platform, and the prefunded payment token identifier can be auto-populated at the payment gateway or checkout page as the prefunded payment token details are previously stored on the merchant database 124.

In a step 504, a data retrieval module of the merchant server 114 retrieves, from the merchant database 124, a balance of a funds value of the prefunded payment token 108 based on the details thereof. For example, the merchant server 114 uses the prefunded payment token identifier to retrieve the funds value balance stored on the merchant database 124. Optionally, the merchant server 114 communicates the funds value balance to the consumer electronic device 112 for the consumer 106 to see.

In a step 506, a transaction processing module of the merchant server 114 compares the transaction amount against the funds value balance. If the transaction amount is determined to be more than the funds value balance, the step 506 proceeds to a step 508 wherein the transaction processing module declines the transaction. Additionally, in the step 508, the transaction processing module may communicate a message to the consumer electronic device 112 to inform the consumer 106 of the declined transaction and the merchant 110 may request the consumer 106 to replenish or allocate more funds to the prefunded payment token 108.

Conversely, if the transaction amount is determined to be less than or equal to the funds value balance, the step 506 proceeds to a step 510 wherein the transaction processing module deducts the transaction amount from the funds value balance for payment of the transaction. In a subsequent step 512, the transaction processing module updates the funds value balance of the prefunded payment token 108 on the merchant database 124. After deducting the transaction amount and updating the funds value balance, in a step 514, the transaction processing module approves the transaction and informs the consumer 106 of the approved transaction, which may be done by communicating a message to the consumer electronic device 112. The message may additionally include the updated funds value balance, and optionally the remaining number of allowed transactions, so that the consumer 106 may consider whether to replenish or allocate more funds to the prefunded payment token 108.

In some embodiments, the prefunded payment token 108 is associated with the funds value, and further associated with a common transaction value and/or an allowed number of transactions. The three transaction parameters may be mathematically correlated. For example, the funds value is the multiplication product of the common transaction value and the allowed number of transactions. It will be appreciated that the merchant 110 determines whether a transaction can be paid using the prefunded payment token 108 based on the collective conditions of the three transaction parameters. In one example, if the allowed number of transactions is 10 and the consumer 106 has already performed 10 previous transactions paid using the prefunded payment token 108, the consumer 106 will not be able to pay for an 11th transaction using the prefunded payment token 108, even though the funds value balance and common transaction value is sufficient for the transaction amount. In another example, if the common transaction value is $10 and the funds value balance is $100, the consumer 106 will not be able to pay for a transaction using the prefunded payment token 108 if the transaction amount is more than $10, even though the funds value balance is sufficient.

According to the method 500, in transactions between the consumer 106 and merchant 110, the merchant 110 can deduct the transaction amounts from the funds value balance as the funds value has already been authorized by the issuer server 120. Transactions paid using the prefunded payment token 108 can be expedited as they do not have to go through the standard payment process, which involves the merchant server 114 communicating with the acquirer server 118 and subsequently the payment network server 102 and issuer server 120 for authorization of each and every transaction. Currently, a transaction is processed through the communication network 122 in the conventional four-party system or three-party system, and often requires the consumer 106 to enter an OTP communicated from the issuer server 120 to the consumer electronic device 112. Typically, a transaction that requires the consumer 106 to enter an OTP takes about 25 to 40 seconds to complete. The method 500 obviates the need for the consumer 106 to enter an OTP communicated from the issuer server 120 each and every time a transaction is performed. The merchant 110 is able to accept payments with the prefunded payment token 108 directly within its internal payment processing system. The merchant server 114 also does not need to communicate with the payment network to process the transaction, such as with the issuer server 120 for authorization. Each transaction can be processed directly between the merchant server 114 and the consumer electronic device 112, and can be completed in about 0.5 to 1 second, subject to internet connectivity speeds between the consumer electronic device 112 and merchant server 114. Thus, the consumer 106 will be able to see that transactions are completed faster than current transactions which require OTPs, thereby improving user experience, especially for high frequency, low value transactions where quicker payments and faster completion of the transactions are desired. Non-limiting examples of high frequency, low value transactions include bill payments, movie bookings, and online/e-commerce purchases.

In some embodiments, the consumer 106 makes a transaction with the merchant 110 to purchase a product. The cost of the product or the transaction amount is $50 and the funds value balance of the prefunded payment token 108 is $100. Thus, the transaction can be entirely paid for using the prefunded payment token 108. The method 500 further includes a step of communicating, from the merchant server 114 to the payment network server 102, a transaction message indicating that the transaction has been paid using the prefunded payment token 108. The payment network server 102 then communicates the transaction message to the issuer server 120 for subsequent settlement of the paid transaction. Particularly, upon settlement of the paid transaction, the transaction amount is transferred from the consumer payment instrument 104 (or an account associated therewith) to a financial account of the merchant 110. Communication of the transaction message across the payment network closes the transaction and may be required for audit purpose.

In some embodiments, the consumer 106 makes a transaction with the merchant 110 to purchase a product. The cost of the product or the transaction amount is $50 and the funds value balance of the prefunded payment token 108 is $10. Thus, the transaction can only be partially paid for using the prefunded payment token 108. In the transaction request communicated from the consumer 106, the consumer 106 provides details of the prefunded payment token 108 together with details of the consumer payment instrument 104 (or another payment instrument of the consumer 106). The consumer 106 further defines a token payment amount for partial payment of the transaction. Notably, the token payment amount is limited to the funds value balance of the prefunded payment token 108. For example, the consumer 106 may define the token payment amount as $10 which is paid by the prefunded payment token 108. The balance payment of the transaction, i.e. the difference between the transaction amount and token payment amount, is paid by the consumer payment instrument 104 or another payment instrument of the consumer 106. The method 500 further includes a step of communicating, from the merchant server 114 to the payment network server 102, a transaction message indicating that the transaction has been partially paid using the prefunded payment token 108. The method 500 further includes a step of communicating, from the merchant server 114 to the payment network server 102, details of the consumer payment instrument 104 for balance payment of the transaction. The payment network server 102 then communicates the transaction message and consumer payment instrument details to the issuer server 120 for subsequent authorization and settlement of the transaction. It will be appreciated that processing of the balance payment of the transaction occurs in a standard manner readily known to the skilled person.

### Technical Architecture

As used herein, a server is a physical or cloud data processing system on which a server program runs. The server may be implemented in hardware or software, or a combination thereof. Some non-limiting examples of the payment network server 102, merchant server 114, acquirer server 118, and issuer server 120 include computers, laptops, mini-computers, mainframe computers, any non-transient and tangible machines that can execute a machine-readable code, cloud-based servers, distributed server networks, and a network of computer systems.

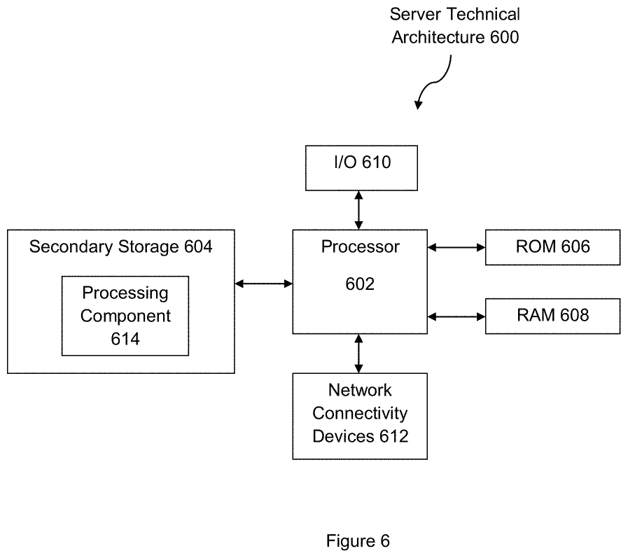

FIG. 6 is a block diagram illustrating a technical architecture 600 of the payment network server 102. The merchant server 114, acquirer server 118, and issuer server 120 may share a similar technical architecture.

The technical architecture 600 includes a processor 602 (also referred to as a central processor unit or CPU) that is in communication with memory devices including secondary storage 604 (such as disk drives or memory cards), read-only memory (ROM) 606, and random-access memory (RAM) 608. The processor 602 may be implemented as one or more CPU chips. Various modules or components for performing various operations or steps of the methods 200/300/400/500 are configured as part of the processor 602 and such operations or steps are performed in response to non-transitory instructions operative or executed by the processor 602. The processor 602 includes suitable logic, circuitry, and/or interfaces to execute such operations or steps. Some non-limiting examples of the processor 602 include an application-specific integrated circuit (ASIC) processor, a reduced instruction set computing (RISC) processor, a complex instruction set computing (CISC) processor, a field-programmable gate array (FPGA), and the like.

The technical architecture 600 further includes input/output (I/O) devices 610, and system connectivity/network devices 612. The secondary storage 604 typically includes one or more memory cards, disk drives, tape drives, or other storage devices and is used for non-volatile storage of data and as an over-flow data storage device if RAM 608 is not large enough to hold all working data. Secondary storage 604 may be used to store programs which are loaded into RAM 608 when such programs are selected for execution.

The secondary storage 604 has a processing component 614 including non-transitory instructions operative by the processor 602 to perform various operations or steps of the methods 200/300/400/500 according to various embodiments of the present disclosure. The ROM 606 is used to store instructions and perhaps data which are read during program execution. The secondary storage 604, the ROM 606, and/or the RAM 608 may be referred to in some contexts as computer-readable storage media and/or non-transitory computer-readable media. Non-transitory computer-readable media include all computer-readable media, with the sole exception being a transitory propagating signal per se.

The I/O devices 610 may include printers, video monitors, liquid crystal displays (LCDs), plasma displays, touch screen displays, keyboards, keypads, switches, dials, mice, track balls, voice recognizers, card readers, paper tape readers, and/or other known input devices.

The system connectivity/network devices 612 may take the form of modems, modem banks, Ethernet cards, universal serial bus (USB) interface cards, serial interfaces, token ring cards, fibre distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communication (NFC), radio frequency identity (RFID), and/or other air interface protocol radio transceiver cards, and other known system connectivity/network devices. These system connectivity/network devices 612 may enable the processor 602 to communicate with the Internet or one or more intranets. With such a system/network connection, it is contemplated that the processor 602 might receive information from the network, or might output information to the network in the course of performing the operations or steps of the methods 200/300/400/500. Such information, which is often represented as a sequence of instructions to be executed using processor 602, may be received from and outputted to the network, for example, in the form of a computer data signal embodied in a carrier wave.

The processor 602 executes instructions, codes, computer programs, scripts which it accesses from hard disk, floppy disk, optical disk (these various disk-based systems may all be considered secondary storage 604), flash drive, ROM 606, RAM 608, or the system connectivity/network devices 612. While only one processor 602 is shown, multiple processors may be present. Thus, while instructions may be discussed as executed by a processor, the instructions may be executed simultaneously, serially, or otherwise executed by one or multiple processors.

The technical architecture 600 may be formed by one computer, or multiple computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the multiple computers. In an embodiment, virtualization software may be employed by the technical architecture 600 to provide the functionality of a number of servers that is not directly bound to the number of computers in the technical architecture 600. In an embodiment, the functionality disclosed above may be provided by executing the application and/or applications in a cloud computing environment. Cloud computing may include providing computing services via a system/network connection using dynamically scalable computing resources. A cloud computing environment may be established by an enterprise and/or may be hired on an as-needed basis from a third-party provider.

It is understood that by programming and/or loading executable instructions onto the technical architecture 600, at least one of the CPU 602, ROM 606, and RAM 608 are changed, transforming the technical architecture 600 in part into a specific purpose machine or apparatus having the functionality as taught by various embodiments of the present disclosure. It is fundamental to the electrical engineering and software engineering arts that functionality that can be implemented by loading executable software into a computer can be converted to a hardware implementation by known design rules.

Furthermore, various embodiments of the present disclosure may be implemented as a method, apparatus, or article of manufacture using standard programming and/or engineering techniques to produce software, firmware, hardware, or any combination thereof to control a computer to implement the disclosed embodiments. For instance, various embodiments may be implemented as a computer-readable medium embedded with a computer-executable program, which encompasses a computer program accessible from any computer-readable storage device or storage media. For example, computer-readable media can include but are not limited to magnetic storage devices (e.g. hard disk, floppy disk, or magnetic strips), optical discs (e.g. compact disc (CD), digital versatile disc (DVD), or Blu-ray disc), smart cards, flash memory devices (e.g. card, stick, or key drive), and solid state drives/memory devices.

In the foregoing detailed description, embodiments of the present disclosure in relation to electronic systems and computerized methods for processing payment of the transactions at the merchant using the prefunded payment token are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

1. A payment network server for processing payment of transactions between a consumer and a merchant, the payment network server comprising:
a tokenization request module configured for:
receiving, from the merchant, a request for tokenization of a payment instrument of the consumer, the tokenization request comprising details of the consumer payment instrument and details of the merchant;
an authorization module configured for:
communicating, to an issuer server for the consumer payment instrument, a request for authorization of the consumer payment instrument, the authorization request comprising the consumer payment instrument details; and
receiving an authorization response from the issuer server, the authorization response comprising authorization of a funds value for payment of the transactions;
a token management module configured for:
generating a prefunded payment token according to the tokenization request, the prefunded payment token associated with the consumer payment instrument, the merchant, and the funds value; and
a communication module configured for:
communicating, to the merchant, details of the prefunded payment token for storing on a database of the merchant and for subsequent communication to the consumer, the prefunded payment token details comprising an identifier thereof and the funds value,
wherein the transactions are payable using the prefunded payment token by deducting, by the merchant, from a balance of the funds value.

2. The payment network server according to claim 1, the prefunded payment token further associated with a common transaction value for each transaction.

3. The payment network server according to claim 1, the prefunded payment token further associated with an allowed number of the transactions.

4. The payment network server according to claim 1, wherein the funds value is determined by the consumer or merchant, the tokenization request and authorization request further comprising the funds value.

5. The payment network server according to claim 1, the authorization module further configured for determining the funds value before communicating the authorization request, wherein the authorization request comprises the funds value.

6. The payment network server according to claim 1, wherein the funds value is determined by the issuer server.

7. The payment network server according to claim 1, the tokenization request further comprising identification details of the consumer, wherein the prefunded payment token is further associated with the consumer.

8. A computerized method for processing payment of transactions between a consumer and a merchant, the method performed by a server of the merchant and comprising:
receiving, from an electronic device of the consumer, a request for tokenization of a payment instrument of the consumer, the tokenization request comprising details of the consumer payment instrument;
communicating the tokenization request to a payment network server, the tokenization request further comprising details of the merchant;
receiving, from the payment network server, details of a prefunded payment token generated by the payment network server, the prefunded payment token associated with the consumer payment instrument, the merchant, and a funds value for payment of the transactions, the prefunded payment token details comprising an identifier thereof and the funds value;
storing the prefunded payment token details on a database of the merchant; and
communicating the prefunded payment token details to the consumer,
wherein the funds value is authorized by an issuer server for the consumer payment instrument; and
wherein the transactions are payable using the prefunded payment token by deducting, by the merchant, from a balance of the funds value.

9. The method according to claim 8, wherein a transaction is payable using the prefunded payment token if an amount of the transaction is less than or equal to the funds value balance.

10. The method according to claim 9, the prefunded payment token further associated with a common transaction value for each transaction, wherein the transaction is payable using the prefunded payment token if the transaction amount is less than or equal to the common transaction value.

11. The method according to claim 9, the prefunded payment token further associated with an allowed number of the transactions, wherein the transaction is payable using the prefunded payment token if previous transactions are fewer than the allowed number.

12. The method according to claim 8, wherein the funds value is determined by the consumer or merchant, the tokenization request further comprising the funds value.

13. The method according to claim 8, wherein the funds value is determined by the payment network server or issuer server.

14. The method according to claim 8, wherein the prefunded payment token details are communicable to the consumer electronic device and/or other electronic devices of the consumer.

15. A computerized method for processing payment of transactions between a consumer and a merchant, the method performed by a server of the merchant and comprising:
receiving a request for a transaction from the consumer, the transaction request comprising details of a prefunded payment token and a transaction amount of the transaction;
retrieving, from the merchant database, a balance of a funds value of the prefunded payment token based on the details thereof;
deducting the transaction amount from the funds value balance for payment of the transaction in response to a determination that the transaction amount is less than or equal to the funds value balance; and
updating the funds value balance of the prefunded payment token on the merchant database,
wherein the prefunded payment token is generated by a payment network server and is associated with the merchant, a payment instrument of the consumer, and the funds value authorized by an issuer server for the consumer payment instrument.

16. The method according to claim 15, wherein the transaction amount is deducted from the funds value balance in response to a determination that the transaction amount is less than or equal to the funds value balance.

17. The method according to claim 16, the prefunded payment token further associated with a common transaction value for each transaction, wherein the transaction amount is deducted from the funds value balance in response to a determination that the transaction amount is less than or equal to the common transaction value.

18. The method according to claim 16, the prefunded payment token further associated with an allowed number of the transactions, wherein the transaction amount is deducted from the funds value balance transaction in response to a determination that previous transactions are fewer than the allowed number.

19. The method according to claim 15, further comprising communicating, to the payment network server, a transaction message indicating that the transaction has been paid using the prefunded payment token, the transaction message for subsequent settlement of the paid transaction.

20. The method according to claim 15, the transaction request further comprising a token payment amount determined by the consumer for partial payment of the transaction.
